(19) United States
(12) Patent Application Publication
(10) Pub. No.: US 2013/0034818 A1
(43) Pub. Date: Feb. 7, 2013

(54) Passive Thermal Impedance Matching Using Common Materials

(71) Applicant: Denny D. Beasley, La Grange Park, IL (US)

(72) Inventor: Denny D. Beasley, La Grange Park, IL (US)

(73) Assignee: ROBERTSON TRANSFORMER CO., Blue Island, IL (US)

(21) Appl. No.: 13/375,060

(22) PCT Filed: Jan. 26, 2011
(86) PCT No.: PCT/US11/22534

§ 371 Date: Oct. 22, 2012

Related U.S. Application Data
(60) Provisional application No. 61/298,406, filed on Jan. 26, 2010.

(51) Int. Cl. F27D 3/00

(52) U.S. Cl. 432/9

(57) ABSTRACT

A device and method for dissipating heat from a source of heat is described. A plurality of layers of thermally conductive materials receives a flow of heat from a source of heat. A first layer of the plurality of layers receives the flow of heat from the source of heat and redirects and transfers the flow of heat to a second of the plurality of layers. Each layer has a separate preselected thermal impedance to control a desired temperature change across the plurality of layers and to maintain a desired operating temperature of the source heat.

### CROSS-REFERENCE TO RELATED APPLICATIONS

The present invention claims the benefit of U.S. Provisional Patent Application No. 61/298,406 filed Jan. 26, 2010, the contents of which are incorporated herein by reference.

### FEDERALLY SPONSORED RESEARCH OR DEVELOPMENT

N/A

### TECHNICAL FIELD

The invention relates to heat management systems. More particularly, the invention relates to heat management systems wherein a heat flow is vectored to enhance rapid dissipation into regions less thermally conductive than the source element. Although applicable anywhere heat flow is critical, an immediate and important application is in lighting and lighting systems, e.g. light emitting diode lighting systems.

### BACKGROUND OF THE INVENTION

The known prior art in thermal management is depicted in FIG. 1. Prior thermal management for a heat source 1 producing a flow of heat 2 typically consists of a larger aluminum heat sink 3 with the metal being formed to move the flow of heat 2 heat from the heat source 1 to a plurality of fins 4. The fins 4 act to expand the surface area of the heat sink 3 so that a very poor conductor, air in this case, can move through the fins 4 and provide a mass flow 5 to carry away the heat. When natural convection is not adequate, a power device typically a blower 6, is used to provide a higher level of mass flow and to gain the desired thermal equilibrium, thus consuming additional energy, increasing the size of the system and adds weight/material/cost.

A disparity of thermal impedances makes this process highly ineffective but nearly universally accepted as an adequate and reasonable approach in the art. The thermal conductivity of aluminum is 171 W/mK° (Watts per meter-degree Kelvin) as compared to that of air at 0.018 W/mK. This is nearly three orders of magnitude difference, and is the primary causal agent heat for heat-sink's bulky physicality.

The need to move the heat without transport losses to the heat exchange surfaces necessitates the use of copper or aluminum. In such a design, the heat flows effectively to the expanded surfaces while fitting into a reasonable space and must allow for unimpeded mass flow for heat transfer to the air. This is not a trivial exercise.

Radiation typically does not come into play in most applications involving living spaces, as these applications require higher temperatures than can be tolerated safely by its human inhabitants. The highest temperature that can be tactically sensed is about 40 to 45° C.—the threshold of pain. The temperature at which reflex action can safely protect someone from injury of burns is about 80° C. The temperature at which radiation is effective is in the order of hundreds of degrees C. Therefore, the use of radiation cooling is not a method compatible with most spaces occupied by people.

A widespread use of light emitting diodes (LED) in industrial lighting is limited by the LEDs sensitivity to temperature. The conventional wisdom is to use classic heat sinking technologies, e.g. finned aluminum, heat pipes, air movement and acoustic oscillation. These methods are expensive and severely limit the design of aesthetically pleasing and practical lighting fixtures.

The present invention is provided to solve the problems discussed above and other problems, and to provide advantages and aspects not provided by prior art of this type. A full discussion of the features and advantages of the present invention is deferred to the following detailed description, which proceeds with reference to the accompanying drawings.

### SUMMARY OF THE INVENTION

One aspect of the present invention is directed to a method of dissipating heat in a light emitting diode lighting system. The method comprises the steps of: (1) providing a light emitting diode as a source of heat; (2) providing a first layer of a first metal having first impedance adjacent the light emitting diode; (3) providing a second layer of a second metal having a second impedance adjacent the first layer; (4) providing a third layer of a third material having a third impedance adjacent the second layer; (5) providing a fourth layer of fourth material having a fourth impedance adjacent the third layer; (6) transferring a flow of heat from the source of heat through the layers such that a temperature drop occurs in each subsequent layer and an operating temperature of the light emitting diode remains constant and within a desired operating range.

A second aspect of the present invention is directed to a method of managing heat from a source of heat. The method comprises the steps of: (1) providing a first layer of a material having a first preselected thermal impedance; (2) providing a second layer of a material having a second preselected thermal impedance; (3) transferring a flow of heat from the source of heat to the first layer; and (4) altering a direction of the flow of heat through the first and second layers using a difference between the first preselected thermal impedance and the second preselected thermal impedance to create a temperature change from the first layer to the second layer.

The second aspect of the invention may include one or more of the following features, alone or in any reasonable combination. The method may comprise the step of altering a ratio of a volume of the first layer to a volume of the second layer to control a desired temperature change from the first layer to the second layer. The method may comprise the steps of providing a third layer of a material having a third preselected thermal impedance and transferring a flow of heat through the first, second and third layers wherein a direction of the flow of heat is altered in each subsequent layer. The method may comprise the steps of providing a fourth layer of a material having a fourth preselected thermal impedance and transferring a flow of heat through the first, second, and fourth layers wherein the direction of the flow of heat is altered in each subsequent layer. The method may comprise the steps of placing the fourth layer in communication with an object of a material having fifth thermal impedance and transferring a flow of heat through the first, second, third layers, and fourth layers to the fifth layer wherein the direction of the flow of heat is altered in each subsequent layer. The method may comprise the step of controlling a desired temperature change from the first layer to the second layer by selecting a thermal impedance differential between the first and second layers to promote redirection of the heat flow through the layers. The method may comprise the step of controlling a desired temperature change from the first layer to the second layer by selecting a thermal impedance differential between the first and second layers to promote redirection of the heat flow through the layers. The method may comprise the step of selecting values of the first and second impedances to allow for an inherent re-vectoring of heat flow into a region of lower thermal density as a response to an external uncontrolled environment to preserve a desired temperature change through the layers. The external uncontrolled environment may be a build-up of dust on one or more of the layers. The method may comprise the step of creating a temperature drop from the source of heat to the first layer and from the first layer to the second layer by controlling the magnitudes of the first and second preselected thermal impedances. The method may comprise the steps of providing a heat exchanger in communication with the second layer and creating a temperature increase from the source of heat to the first layer and from the first layer to the second layer by controlling the magnitudes of the first and second preselected thermal impedances.

The second aspect of the invention may further include one or more of the following features, alone or in any reasonable combination, which may also be combined with the above stated additional features. The source of heat and the first and second layers may be in stacked relationship wherein the source of heat engages a first surface of the first layer and the second layer has a surface engaging a second surface of the first layer opposite the first surface of the first layer. The method may further comprise the steps of providing a third layer of a material having a third preselected thermal impedance in stacked relationship with the second layer and engaging a surface of the second layer opposite the first layer; transferring the flow of heat from the second layer to the third layer; and creating a desired temperature change from the second layer to the third layer by selecting a thermal impedance differential between second and third layers. The method may further comprise the steps of providing a fourth layer of a material having a fourth preselected thermal impedance in stacked relationship with the third layer and engaging a surface of the third layer opposite the second layer; transferring the flow of heat from the third layer to the fourth layer; and creating a desired temperature change from the third layer to the fourth layer by selecting a thermal impedance differential between third and fourth layers. The method may further comprise the steps of providing a fifth layer of a material having a fifth preselected thermal impedance in stacked relationship with the fourth layer and engaging a surface of the fourth layer opposite the third layer; transferring the flow of heat from the fourth layer to the fifth layer; and creating a temperature change from the fourth layer to the fifth layer by selecting a thermal impedance differential between fourth and fifth layers. The fifth layer may be an environmental object produced from a material selected from the group consisting of: a polymeric material; a cellulose material, a ceramic, a glass, a metallic material. Magnitudes of the preselected thermal impedances of the first, second, and third layers may descend in value from the first layer to the third layer. Magnitudes of the preselected thermal impedances of the first, second, and third layers ascend in value from the first layer to the third layer. Each of the first, second and third layers may have a volume wherein the third layer volume is greater than the second layer volume and the second layer volume is greater than the first layer volume.

Another aspect of the present invention is directed to a device for dissipating heat from a source of heat comprising. The device comprises a source of heat and a plurality of layers of thermally conductive materials. A first layer of the plurality of layers receives a flow of heat from the source of heat and redirecting and transferring the flow of heat to a second of the plurality of layers wherein each layer has a separate preselected thermal impedance to control a desired temperature drop across the plurality of layers and to maintain a desired operating temperature of the source heat.

This aspect of the invention may include one or more of the following features, alone or in any reasonable combination. The plurality of layers may comprise layers of metallic and non-metallic materials. The preselected thermal impedances may be at least partly controlled by a volume of each layer. The layers may be in a stacked relationship wherein the source of heat is adjacent a surface of the first layer and the second layer is adjacent an opposite surface of the first layer. A third and fourth layer may be in stacked relationship with first and second layers, and the magnitude of the preselected thermal impedance of each subsequent layer moving in a direction away from the source of heat is less than the magnitude of the preselected thermal impedance before it. A final layer may comprise an environmental object of a cellulose fiber structure. A final layer may comprise an environmental object of a metallic material. The source of heat may be a light emitting diode.

Other aspects of the invention are presented in the figures and the detailed description set forth below.

### BRIEF DESCRIPTION OF THE DRAWINGS

To understand the present invention, it will now be described by way of example, with reference to the accompanying drawings in which:

FIG. 1 illustrates a typical prior art approach to thermal management;

FIG. 2 illustrates thermal flow in dissimilar materials with a single heat source;

FIG. 3 illustrates mechanical analogy of energy flow and mechanical energy flow;

FIG. 4 illustrates a mechanical analogy with impedance matching removed;

FIG. 5 illustrates an electrical analog of a heat source with internal thermal impedance and an attached thermal sinking device;

FIG. 6 illustrates a thermal impedance matching network schematic with a series of sequenced thermal impedances;

FIG. 7 is a finite element analysis of a network with isotherms and heat flow vectors;

FIG. 8 is a network having a thin steel final layer;

FIG. 9 is an alternate schematic view of the network of FIG. 8;

FIG. 10 is a cross-sectional view showing an unwrapped final layer of the network of FIG. 8;

FIG. 11 is a network comprising of concentric rings;

FIG. 12 is a cross-sectional view of the network of FIG. 11;

FIG. 13 is a solar application of a thermal network;

FIG. 14 is an illustration of an impedance match made of two discrete materials in a composite layer;

FIG. 15 is an illustration of layer averages of unequal-sized layers to layer values for matching;

FIG. 16 is an illustration of layers made of the suspension of one material in another;

FIG. 17 is an illustration of a diffusion thermal impedance matching layer

FIG. 18 is a schematic representation of a prior art thermal management system;

FIG. 19 is a plot of a distribution of heat flux density just below the fins of the system of FIG. 18;

FIG. 20 is a plot of a temperature distribution along boundary below the finned areas of the system of FIG. 18.

FIG. 21 is a schematic representation of a thermal management system of the present invention;

FIG. 22 is a plot of a temperature distribution along a test boundary between layers shown in FIG. 21;

FIG. 23 is a plot of heat densities along a test boundary of the system shown in FIG. 21;

FIG. 24 is a schematic representation of a thermal management system of the present invention;

FIG. 25 is a plot of a temperature distribution along a test boundary between layers shown in FIG. 24;

FIG. 26 is a plot of heat densities along a test boundary of the system shown in FIG. 24;

FIG. 27 is a plot of a tangent component of the heat flux at the test boundary of the design of FIG. 24;

FIG. 28 is a schematic representation of a thermal management system of the present invention;

FIG. 29 is a schematic representation of a thermal management system of the present invention; and

FIG. 30 is a schematic representation of a thermal management system of the present invention.

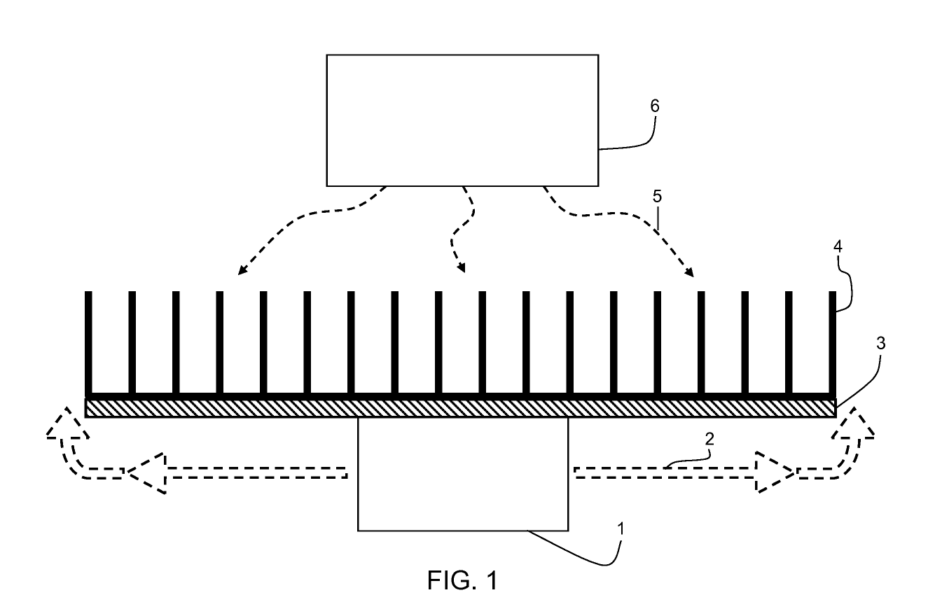

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

This invention relates to the removal of heat from operating devices that generate waste heat as a byproduct of normal operation. These operating devices require some means to remove this heat for long life, for limiting the temperature for safety, and/or for maintaining an operating temperature within a desired or prescribed range. Broadly speaking, a device of the present invention acts to move heat through primarily conductive means as opposed to radiation or convective means. Use of this invention allows heat to be safely and efficiently extracted with low rises in temperature via use of inexpensive, available, and recyclable materials. In most applications, a device of the present invention can reduce the use of metals in a heat management system by 70 to 90 percent while providing thermal management equal to, and in some circumstances, exceeding other well-know and accepted means (e.g. such as extruded aluminum heat sinks and blowers). Since it eliminates the need for secondary heat removal instruments (e.g. a blower) to provide mass flow for heat removal, a higher level of efficiency is obtained without loss of effectiveness.

The present invention allows heat removal through surfaces and boundaries that normally would be considered thermal non-conductors, while at the same time, keeps the average temperature of the materials of the surfaces and boundaries well below safe levels for human exposure and combustive limits. The invention allows an array of materials—organic, recyclable, low cost, lightweight fibrous and non-rare earths such as clay and glass to be used for high volume applications, such as lighting.

All materials have a propensity for heat conduction. Metals generally have the highest conductivity expressed in Watts per Meter degree Kelvin (W/mK). Silver (428 W/mK), copper (401 W/mK) and aluminum (171 W/mK) are widely accepted as efficient conductors. However, silver and copper are infrequently used as prime thermal conductors due to cost constraints. Aluminum has an added benefit of being easily extruded, thus allowing it be quickly formed into designed shapes for optimal heat transfer. Gasses, as a result of their low densities, have some of the lowest thermal conductivity. Air has a thermal conductivity of 0.018 W/mK. To provide the same square millimeter of heat flow of aluminum, it requires 9500 mm² of air.

The present invention matches thermal impedances to optimize the flow of heat. The structures and consequences of using such a method are described herein.

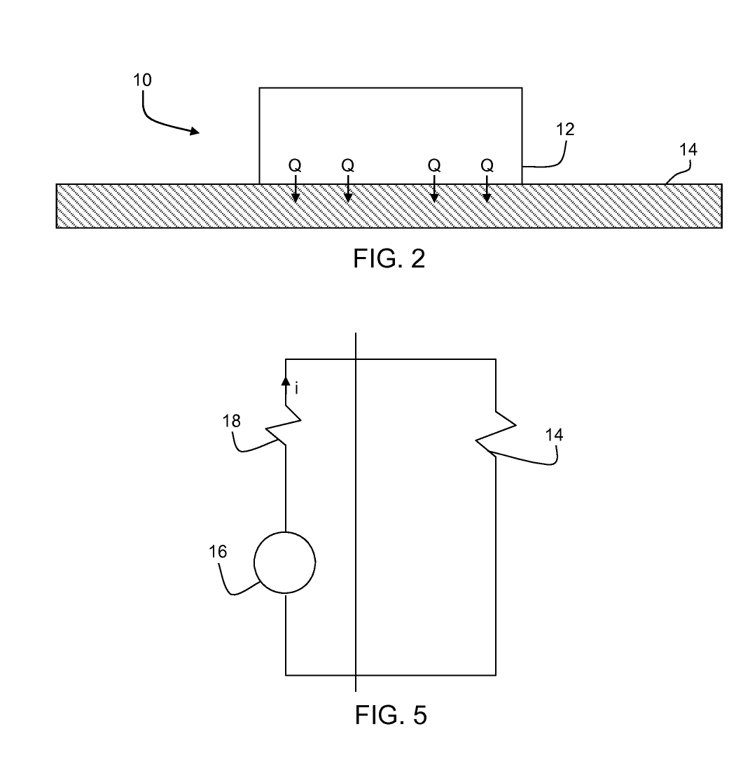

Referring to FIG. 2, a two element thermal system 10 is illustrated. The system 10 includes a heat source 12 embedded in a heat sink 14 of a first material, e.g. aluminum, and attached to a second material, preferably having a thermal conductivity of 0.10 W/mK. A heat flow Q is generally dissipated via the heat sink 14.

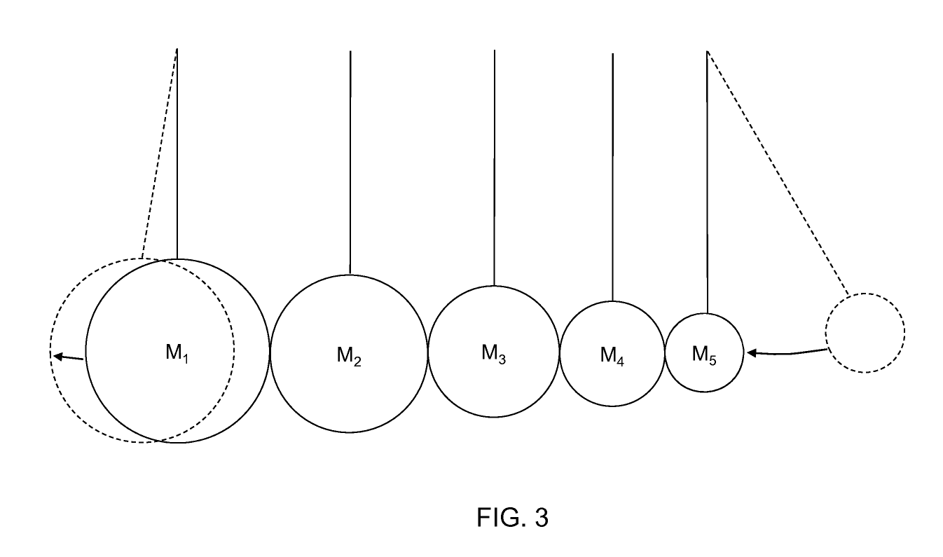

An impedance matching is critical to the invention and comes from several disciplines. One classic example is a desk toy consisting of a sequence of masses as seen in FIG. 3. Masses M₁, M₂, M₃, M₄, and M₅ are arranged in descending magnitude from left to right. Initially, the masses M₁, M₂, M₃, M₄, and M₅ are not in an excited condition. If the smallest mass, M₅, is excited—elevated to acquire an amount of potential energy in the gravitational field—then released, the smallest mass M₅ will substantially transfer its kinetic energy through the intermediate masses, M₄, M₃, and M₂, to the largest mass, M₁.

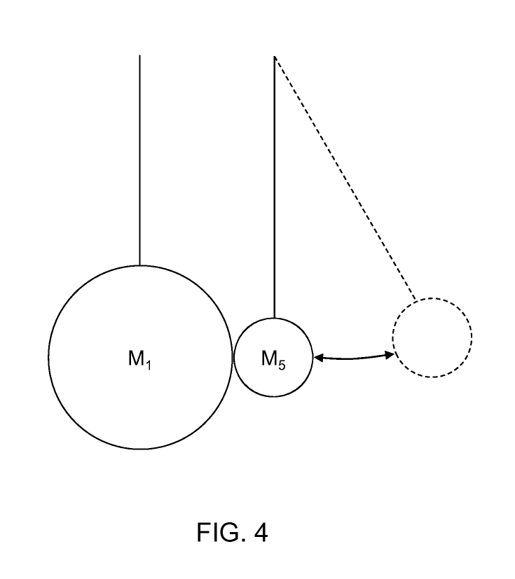

As illustrated in FIG. 4, when the intermediate masses, M₄, M₃, and M₂, are removed, the same excitation of the smaller mass, M₅, will have a much different outcome. Instead of a substantial amount of energy being transferred to the larger mass, M₁, the smaller mass, M₅, will retain nearly all of its kinetic energy, albeit in the opposite direction, after the collision.

This is an example of mechanical impedance matching and can be applied to any flow of energy through any medium. The example uses mechanical energy because it is generally agreed that thermal energy is a mechanical process and therefore the example has a direct correlation to the subject of this invention.

The electrical analogy of this mechanical process can be seen in FIG. 3. The mass 14 with embedded heat source 12 of FIG. 5 is replaced by its electrical analog, a voltage source 16 and a series impedance 18. This provides the current i that is the electrical analog of heat flow Q. The principle of maximum power transfer is well-known in electrical engineering and it states: “maximum energy transfer occurs when the load impedance equals the source impedance.” Having established the analogic basis between mechanical/thermal behavior and further to its electrical analog and using the principles of maximum energy transfer, the maximum energy transfer in the mechanical/thermal system will occur when the thermal impedances are equal. As discussed above most thermal systems have a high degree of mismatch (e.g. between the aluminum heat and air).

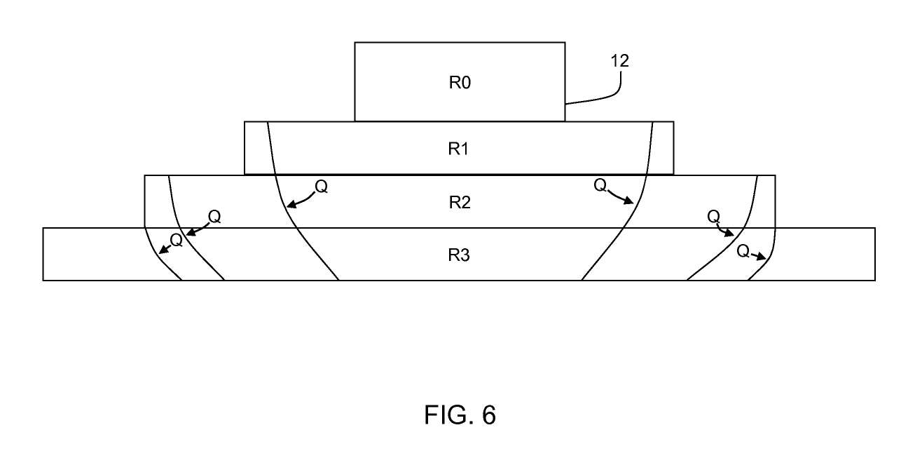

To achieve a thermal match, applying the mechanical analogy, the answer to thermal impedance match is, as in the case of ascending/descending masses, having the thermal impedances in an ascending/descending progression. This arrangement is shown in FIG. 6. A structure of having progressively lower thermal impedances and progressively increasing areas R0,R,R2,R3 is depicted. For thermal impedance match:

R0≦R1≦R2≦R3KR∞ (1)

A study of the units for thermal impedances teaches that to maintain a thermal match, the minimum requirement is reasoned with the following argument. The unit of thermal conductivity is Watts per meter degree Kelvin (W/mK°). However, this is a reduction of the equation Watt-meter per meter²-K° (Wm/m²-K°). This is shown in equation

$$\frac{Wm}{{m}^{2} K °} \qquad ( 2 )$$

where m² is area. The following derivation shows the needed area differences for equal heat flow at the same temperatures and layer thickness. For two materials at the same temperature to conduct the same amount of heat at equal temperatures and for maximum transfer:

$${T}_{C 1} = {T}_{C 2}$$

$${x}_{1} \neq {x}_{2}$$

$${w}_{1} = {w}_{2}$$

$$\frac{{x}_{1} * Wm}{{m}_{1}^{2} K °} = \frac{{x}_{2} * mM}{{m}_{2}^{2} K °}$$

Only the areas can be manipulated, so for equal heat flow at equal temperature:

$$\frac{{x}_{1}}{{x}_{2}} = \frac{{A}_{2}}{{A}_{1}} \qquad ( 3 )$$

For example, if:

x₁=171

x₂=43

for equal heat flow at equal temperature difference, where:

$${m}_{1} = 100 {mm}^{2}$$

$$\frac{171}{43} = \frac{{A}_{2}}{{A}_{1}}$$

$${m}_{2} = \frac{171}{43} * 100 {mm}^{2}$$

$${m}_{2} \approx 400 {mm}^{2}$$

If a design allows a three dimensional approach, then an approach such as shown below in equation 5 can be used to approximate a material requirement using a radial distance to area ratio, where L₁ and L₂ are radial distances.

$$\frac{{W}_{1} * {L}_{1}}{{A}_{1} K {°}_{1}} = \frac{{W}_{2} * {L}_{2}}{{A}_{2} K {°}_{2}} \qquad ( 4 )$$

For the isothermal case:

K°₁=K°₂

W₁=W₂

T_{C1}≠T_{C2}

For equal heat flow and variable radial lengths and areas:

$$\frac{{T}_{C 1}}{{T}_{C 2}} = \frac{\frac{{L}_{2}}{{A}_{2}}}{\frac{{L}_{1}}{{A}_{1}}} \qquad ( 5 )$$

### Additionally:

Q_{R}=Radial·Flow

Q_{Z}=Axial·Flow

Heat·Vector=Q_{R}+Q_{Z}

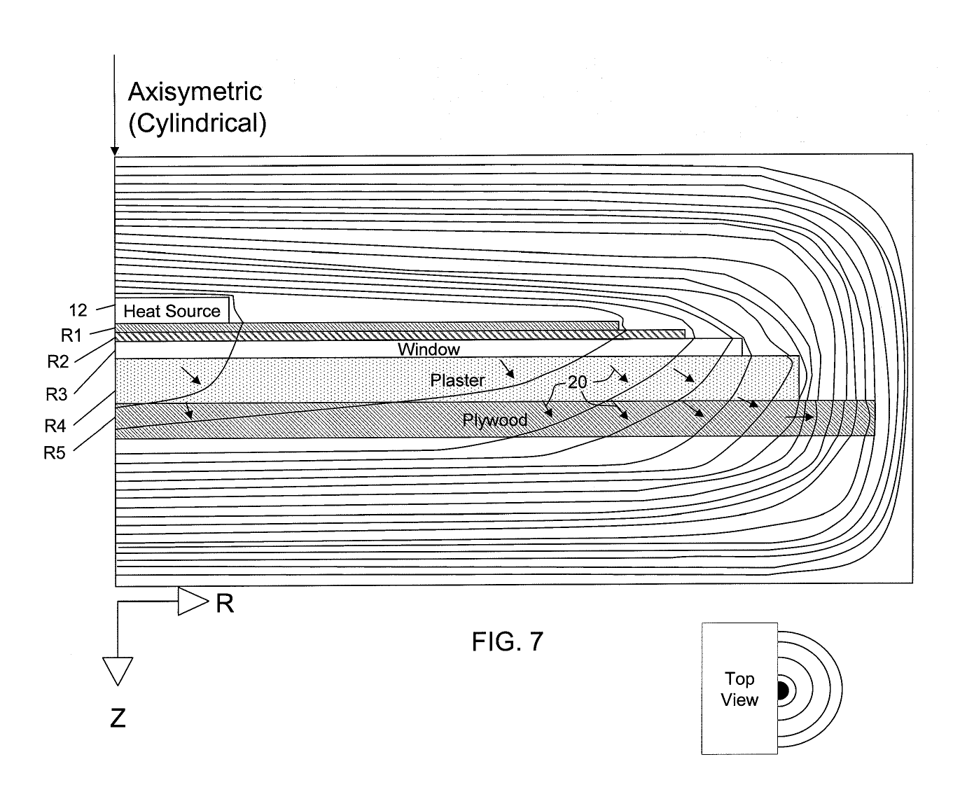

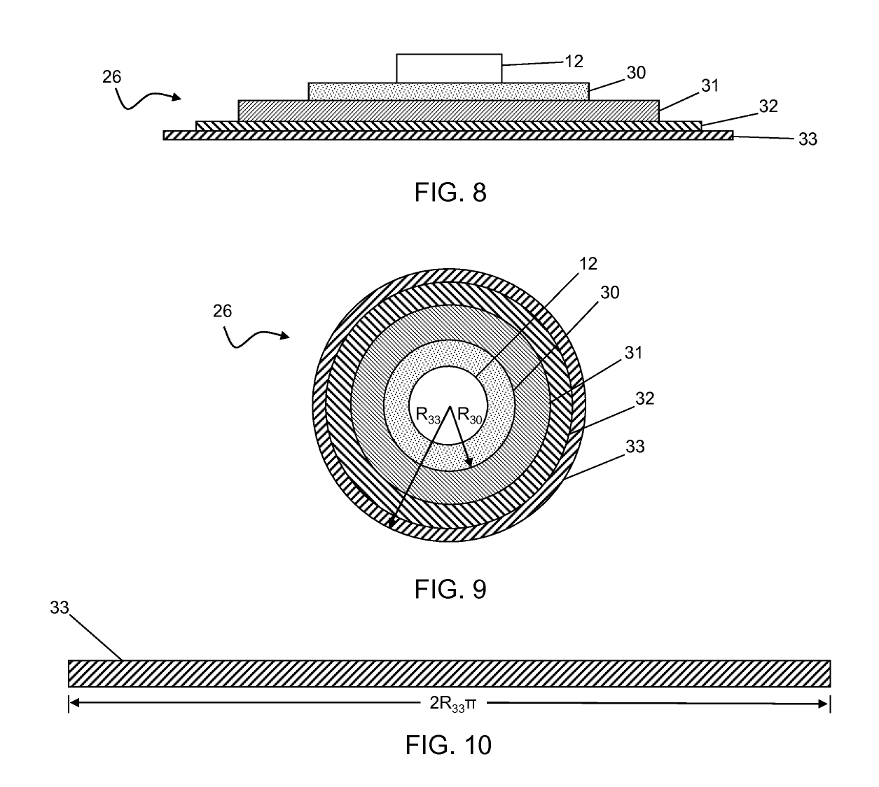

FIG. 7 shows an impedance matching device in a cylindrical coordinate system. In this framework, the heat is vectored into the Z-axis and the radial-axis consistent with equation 4. The local heat flow vectors 20 are seen in the heat flow simulation in FIG. 7, and it is everywhere orthogonal to the isometric boundary. Each isothermal boundary is a temperature change of 0.011 degrees Kelvin. It can be seen from the average temperature of each layer that there is a very uniform distribution of temperature. The heat source layer is 319.8° K, the next layer 318.5° K, the next 317.8° K and the last layer 313.38° K. The layers of materials in this example R1,R2,R3,R4,R5 are aluminum, steel, glass, plaster (or drywall), and plywood, respectively.

The average temperature demonstrates that each layer has moved the temperature gradient to a nearly uniform-radial-distribution over each subsequent layer and, therefore, fully utilizes the available areas for heat transport. Conversely, a much lower average temperature would indicate a rapid reduction in temperature and, therefore, a rapidly reducing radial temperature and declining heat flow.

The described simulation is derived from the effects of the maximum power transfer theorem. For electrical circuits, it would be the point where the voltage drop across the load is the same as the voltage drop across the internal source impedance. The only difference is that temperature on the absolute Kelvin scale causes some confusion. It is, thus, helpful to define a local condition, i.e. the total temperature is the local temperature differential.

In the example, ambient temperature is 22° C. (298° K), and the source/first layer is 42° C. (319° K) therefore the local differential is 20° C. To meet the criteria for maximum transfer, the temperature needs to ideally drop 10° C. across the impedance matching network. The total drop is in the simulation and across the impedance matching is about 7° C. This would indicate that we have not reached an ideal condition and would require adjustment of one of the layer thicknesses or areas. However, the simulation does not handle less than ideal boundary conditions well. In reality, the drop is typically higher than shown in the simulation.

The design is critical in the first layers nearest the heat source and less critical as in subsequent layers moving away from the heat source 12. This allows designs to be fabricated on large sheets of the least costly materials while not significantly impacting the overall performance. The first layers provide strong vectoring of heat flow and must not be smaller than prescribed by the invention design criteria. Once vectored, the final layers are less important and can have deviations larger than design without significant impact. However, the extra materials do not significantly change the operational outcome. This has practical importance to the extent the inventor contemplates the addition of materials outside the local boundaries of primary heat flow and would clearly fall within the intended scope of the invention as understood by one of ordinary skill in the art. On the contrary, additional materials could allow for inherent flow re-vectoring in a case where a dirt layer could accumulate on the final layer. This could be anticipated in a design and thus, the extra materials allow the heat to re-vector into, as the final thermal layer is altered, preserving the functionality. This would provide and inherent adjustability to the design allowing it to adapt to changing environmental changes, such as accumulation of dust and dirt or other environmental conditions likely to be encountered by a thermal management system of the present invention.

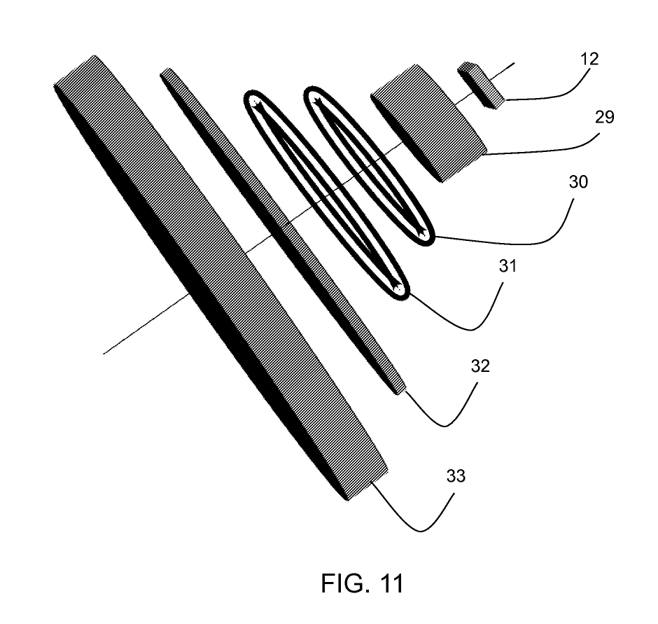

The matching network has many possible variations that can provide good thermal matching to thin layers, such as steel furniture. The steel outside of the furniture is typically between 5 and 10 thousandths of an inch thick. In FIG. 10, a network 26 is a typical design for a thin-wall steel configuration. The network comprises multiple layers 30,31,32,33. The first layer 30 is generally aluminum. The final layer 33 is the steel layer and has a very small radial cross-section and, therefore, a high thermal impedance looking from the center of the heat source outwardly. (See FIG. 9). The next step is counterintuitive, insert a low thermal conductive material.

Two criteria must be met for this to be meaningful. The thermal impedance needs to be chosen to cause a great enough temperature drop to provide a strong radial vectoring. Two common materials, but by no means the only two, are brass and a thin polyester film, preferably Mylar® (Mylar® is a registered trademark of E.I. du Pont de Nemours and Company Corporation), in layers 31,32 before the final steel layer 33. The thermal conductivity transition between the two materials vector the heat out radially until the cross section at the final radius R₃₃, in the steel final layer 33, for good heat transfer. At R₃₃, the cross-section would appear, if unwrapped from the perimeter, as shown in FIG. 10, a long, slim rectangle. R₃₃ is the perimeter where the cross-sectional area of the section approaches the cross-section in the impedance matching network. Near this radius and beyond, thermal heat transfer is effective. For this reason the network 26 could be a series of concentric rings that are stacked as shown in FIG. 11.

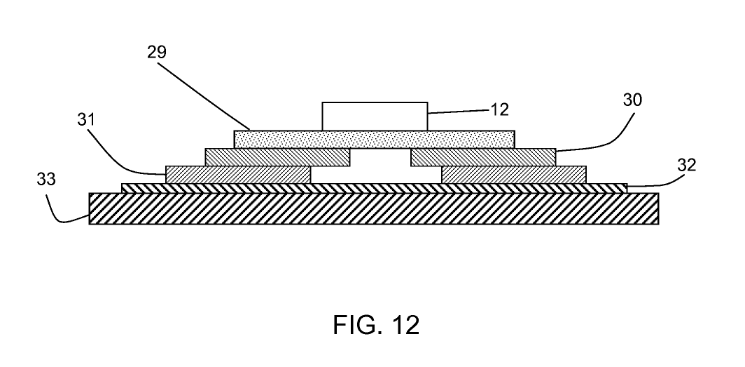

In FIG. 11, a stack is formed by a first thermal layer 29. The first layer 29 is typically a solid material, as the source is typically located in the center of the initial layer, for example solid copper. The next layers 30,31 are concentric rings followed by a layer 32 of polyester film, e.g. Mylar®, and the final layer 33, e.g. a thin steel layer. It should be noted that although this provides for the minimum use of materials, it could be all solid without loss of effectiveness. See also FIG. 12.

Broadly speaking, the invention is not limited to any particular physical shape or material dimension. However, one of ordinary skill would readily understand that in each geometry, where the invention is applied, the sequence of material thermal/impedance transitions, to meet the geometric condition, could be much different than described. However, the transitions will substantially be sequenced in ascending or descending order of thermal impedances

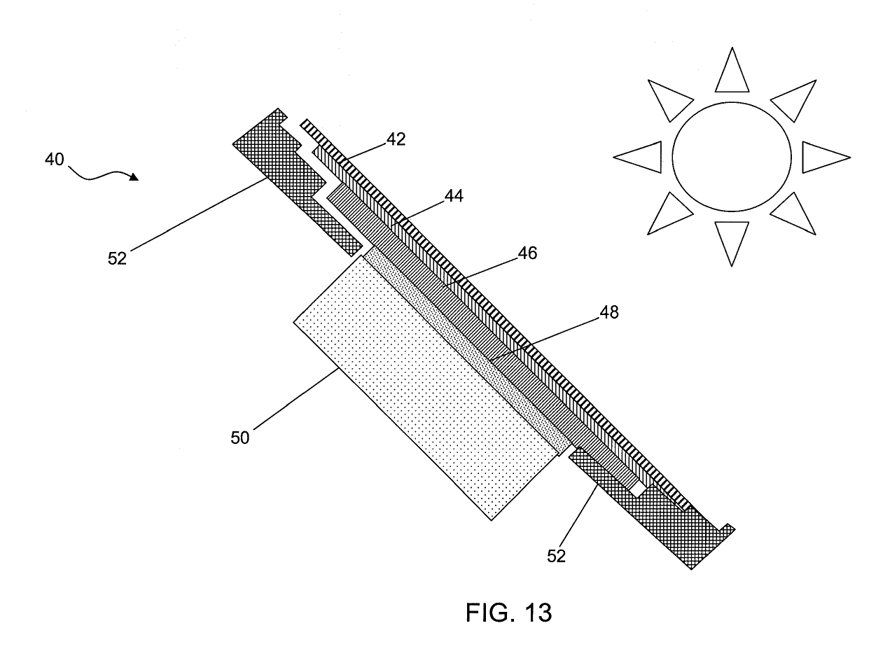

It is important to remember that the impedance network is bi-directional and has solar applications for non-optical collection and redirection of solar energy. FIG. 13 shows the use of a thermal network 40 collecting a diffuse thermal energy and, through a progressive thermal mass, concentrating the thermal flow to a smaller area where it can be effectively collected. The network 40 is composed of, but not limited to, a glass layer 42, a steel layer 44, an aluminum layer 46, and a final copper layer 48 to which a heat exchanger 50 is attached. To prevent heat loss to the air, a layer of insulation 52 is provided opposite the glass. For best absorption of the visible solar energies, a second steel layer 44 just below a glass layer 42 would be black in color. The glass layer 42 traps the infrared energies, giving the invention a broadband absorption characteristic unlike solar voltaic cells which are much narrower band collectors.

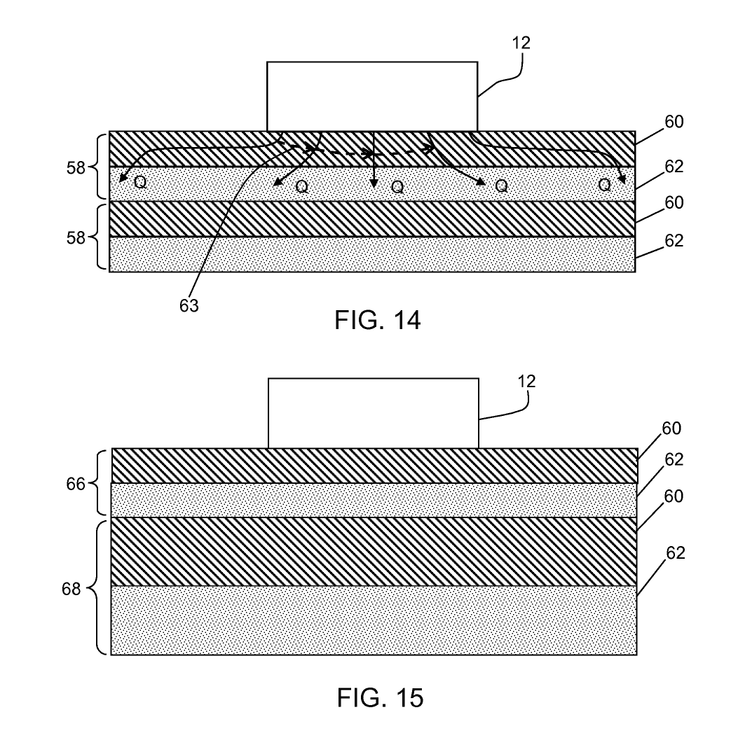

Another method of achieving a thermal impedance match is to use as few as, but not limited, to two materials and a minimum condition that is repeated as shown in FIG. 14. The figure shows a composite layer 58 formed from two discrete materials, a metallic layer 60, e.g. copper 60, and a second layer 62, preferably a temperature resistant, flame retardant nylon, such as Nomex® (Nomex® is a registered trademark of E. I. du Pont de Nemours and Company Corporation), or a fiber paper. Each copper 60/Nomex® 62 composite layer 58 creates an averaged thermal impedance to the heat source 12. It should be noted that, in FIG. 14, the layers are shown equal thickness, width and length. This is for explanation purposes only and not a requirement of inventive method. This composite layered form 58, having alternating layers of high and low thermal conductivity, creates a thermal impedance layer that meets the criteria of transition layers that approach the thermal impedance of the final heat sinking layer as explained previously. Isotherms 63 for a heat flow Q are shown.

The calculation of the minimum condition for a thermal matching device utilizing layer-averaging is set forth below. Providing only two layers, however, would represent a poor impedance match and would transfer heat poorly. The greater the number of layers, and thus the greater the transitional granularity, the better the heat transfer.

Equation 6 shows the simple averaging process given the criteria previously described.

$${T}_{H 2} = 0.5 {T}_{H 1} \\ {T}_{Havg} = \frac{( {T}_{H 1} + {T}_{H 2} )}{2} \\ {T}_{Havg} = \frac{1.5}{2} * {T}_{H 1} \\ {T}_{Havg} = 0.75 {T}_{H 1} \qquad ( 6 )$$

The thermal impedance for this explanation is shown as T_{H1}, T_{H2} and T_{Havg} for a single composite layer. For the sake of explanation, T_{H2} is known to be half of T_{H1}. The results are of the averaging process for a first composite layer 58. The averaging process for a pair of composite layers is set forth below.

$${T}_{Havg} = \frac{( {T}_{H 1} + {T}_{H 2} )}{2} \\ {T}_{{Havg}_{L * L}} = \frac{( {T}_{Havg 1} + {T}_{Havg 2} )}{2} \\ {T}_{{Havg}_{L * L}} = {T}_{H 1} * \frac{( \frac{1.5}{2} + \frac{1.5}{2} )}{2} \\ {T}_{{Havg}_{L * L}} = {T}_{H 1} * \frac{3}{2} * \frac{1}{2} \\ {T}_{{Havg}_{L * L}} = 0.75 {T}_{H 1} \qquad ( 7 )$$

We see that the average of the averaged layers is the same. This has created the thermal equivalent of the distributed impedances in a transmission line, where, for example, the impedance of a cable could be 50 Ohm no matter how long it may be. However, the goal is to transition from two very different thermal impedances to improve transfer.

To accomplish this, average layer to average layer must be incrementally different. This can be seen in FIG. 15 where each composite average layer is ½ of the previous layer for example purposes. This is accomplished by either adjusting layer thickness or thickness to volume ratio of one or both of the two materials in the composite layer 66. Now, there is graduated transition averaged layer to averaged layer where the averaged value of the composite layer 68 is half that of composite layer 66 etc. Equation 8 describes the average process:

$${T}_{{Havg}_{Total}} = \frac{( {Average}_{1} + {Average}_{2} )}{2} \\ where \text{:} \\ {Average}_{1} = \frac{1}{2} {Average}_{2} \qquad ( 8 )$$

This process would continue until the temperature drop for the given heat flow is equal to half the thermal differential, thus fitting the maximum transfer theorem for heat flow. The calculation and the potential variations and layer type and dimensions are not detailed due to the shear volume of options as would be readily understood by one of ordinary skill in the art.

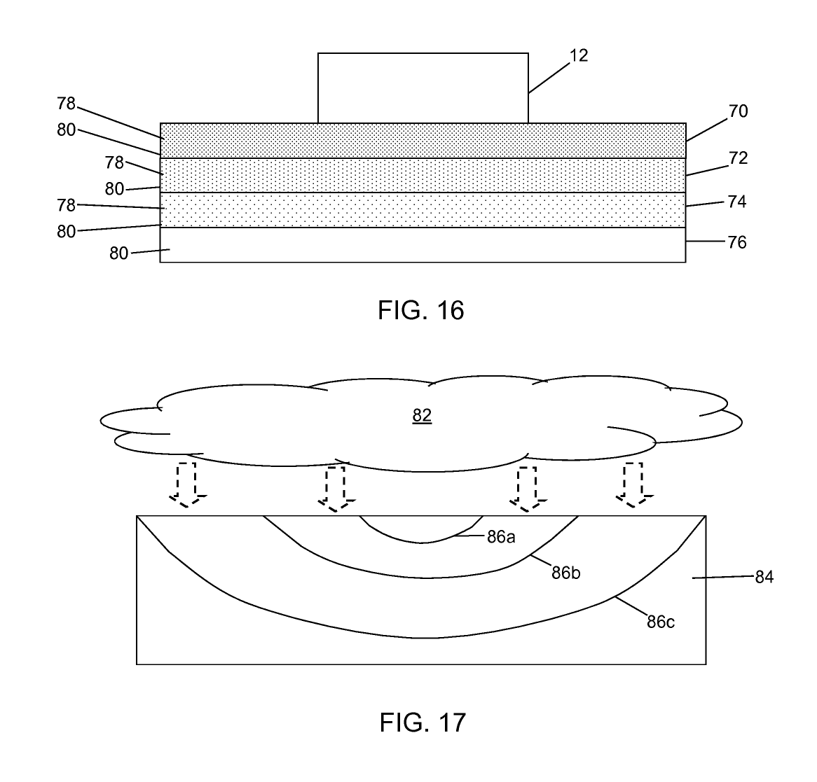

An additional variation is to have a graduated suspension of a high thermal conductivity material in another of lower thermal conductivity. FIG. 16 illustrates a plurality of layers, e.g. four layers 70,72,74,76 where a material 78, e.g. a conductor, such a metal like copper or aluminum, is interspersed in a clay substrate 80. Although shown as layers it could be a graduated distribution over a clay block. The dot density in FIG. 16 represents the level of (or ratio) of high conductivity to low conductivity such that each subsequent layer has a decreasing ratio of high conductivity material 78 to low conductivity material as the layers move away from the heat source 12. Showing it in discrete form allows use of the graduated layer explanation previously described.

Referring to FIG. 17, an additional variation is to use the principle of diffusion to diffuse a higher thermal impedance material 82 (e.g. a metal) into a lower thermal impedance 84 material (e.g. a ceramic). This would generate a continuum of thermal graduations 86a,86b,86c and the most ideal thermal matching. The layer would be designed for specific heat flows and differential impedances and follow the rules of maximum energy transfer for heat.

The present invention immediately finds application in light emitting diode lighting systems. It allows the ordinary surfaces—walls, floors, ceiling tiles, concrete walls to become viable heat sinks for LED lighting. It is purely passive and uses the most ordinary materials. It includes unique counter-intuitive characteristics such as—when 60 watts of LEDs are mounted and operating on a half inch thick piece of paperboard by two foot square (a ceiling tile) positioned horizontally, the temperature equilibrates to design level—place fiberglass insulation on top and the temperature will not rise—if the insulation to paperboard interface is good the temperature will drop.

### Example

One practical application of the invention is removing heat from an LED lighting system. The described technique can be implemented to decrease the application limitations of LEDs while reducing the carbon footprint associated with the heavy use of metals such as copper, aluminum and steel. Metal usage can be reduced by 80% and substituted with common recyclable/degradable materials such as wood, concrete and plastics. This is accomplished with an engineered thermal impedance matching/thermal vectoring network that transitions the heat from the source to subsequent intermediate layers that provide rapid dispersal of the heat to background materials and structures such as walls, floors, ceilings and ceiling tiles. This allows LEDs to be deployed in a rational, ecological manner with a much smaller environmental impact.

All materials can conduct heat, some much better than others. Classically only very high thermally conductive materials, e.g. copper and aluminum are used in the construction of heat removal devices. However, this approach albeit functional does not fill the need of form and function needed to allow LEDs to come to highest level of utilization in most lighting applications.

To gain a full perspective of the approach, it is best to understand the materials that could be involved or encountered in a user environment. Table 1 gives a brief sketch of some of those materials and an approximation of that materials thermal conductivity.

TABLE 1
Thermal Conductance of Commonly Encountered Materials

| Material type | Watts/m²K |
|---|---|
| Diamond | 1000 |
| Copper | 401 |
| Aluminum | 171 |
| Stainless Steel | 14 |
| Concrete | 1-1.1 |
| Window glass | .84 |
| Plastic | .5 |
| Plaster | .5 |
| Human skin | .37 |
| Maple Wood | .17 |
| Fiberglass | .035 |
| Air | .014 |

From Table 1 several observations can be made. The most obvious is that all heat sinks should be fabricated from diamonds—albeit expensive—and could only add to the glamour of LED lighting. At a more practical level, the materials commonly used are aluminum and air. The thermal conductance of aluminum and air differ by a ratio of more than 12,000:1. According to the principles of the invention described above, this is an undesirable impedance matching condition.

Several conditions have to be met for the proper impedance/conductance matching according to one aspect of the invention to take place. The use of impedance matching is used as generic term for the matching process. Heat much be moved in such a way as to create an optimal thermal distribution to deliver heat flux densities that match with the materials heat flow capabilities. This is nearly impossible with homogeneous material structures such as a typical heat sink.

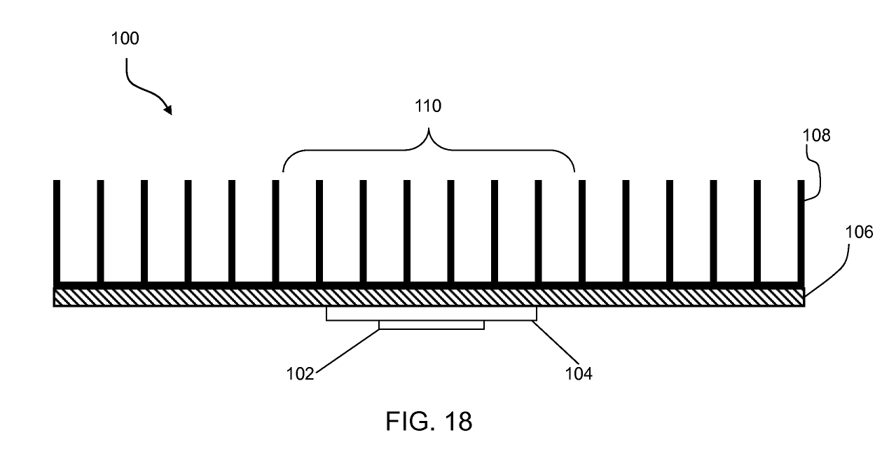

FIG. 18 is a schematic diagram representing a lighting system 100 having a string of LEDs 102. The LEDs 102 are mounted on a copper bar 104 and attached to an aluminum heat sink 106 having a plurality of fins 108. The LEDs have a total heat contribution of 12 watts, and the dimensions of the system 100 are 3.35 ins×5.15 ins×2 ins. A distribution of the temperatures in the system 100 showed that the highest drop in temperature occurred at the air/fin interface. This system 100 was highly ineffective at moving the heat from the operating device. In this example, with 12 watts and an ambient of 300° K with natural convection, the temperature rise in the center of the copper bar 104/LED 102 interface boundary was 15° K to 315° K. Any obstruction that would interfere with air movement would be catastrophic to operating this device 100.

The heat sink occupied a volume of 34 cubic inches and 400 grams. The volumetric requirements that the structure needed to occupy for adequate operation in the less the optimal orientation shown, was at least twice its physical displacement needed to provide space enough for establishment of real convection.

The physical structure illustrated in FIG. 18 was ineffective at moving the heat from its target thermal load as the heat flow tries to vector into the outer areas of the heat sink 106 of the fin header. The system 100 did not effectively move heat to the outer regions for removal. It was clear that the structure could move more heat if it were distributed uniformly over the header region 106.

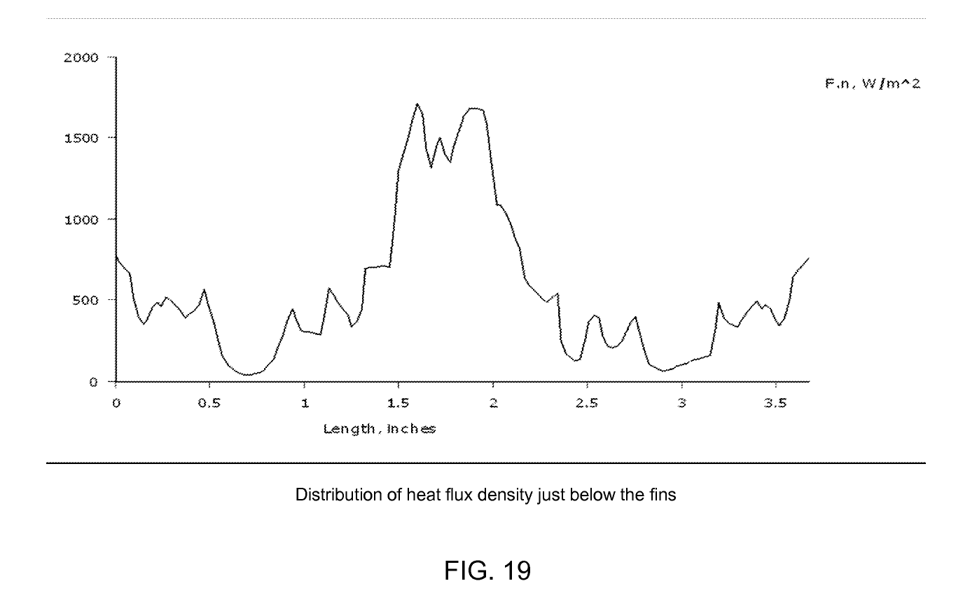

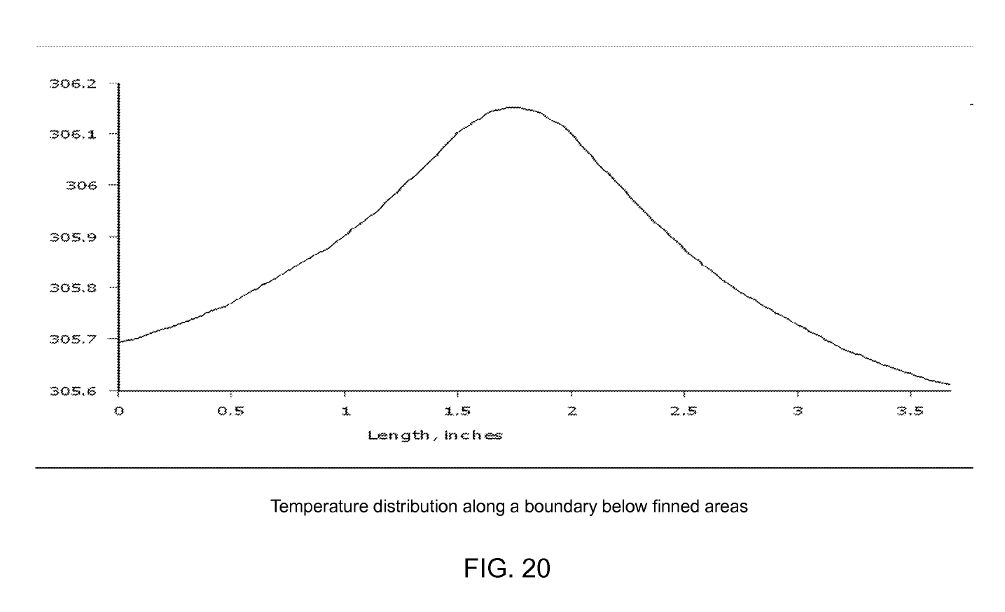

FIG. 19 is a plot of the flux distribution along a line between the copper 104 and the heat sink 106. It is clear that the density bunching in that region focuses the heat flow to the fins 108 immediately above the LED bar 104. It is apparent that the center 30% is handling 80% of the thermal loading in the heat sink (see also FIG. 18, reference 110). Thus, it is clear more metal does not always equate to cooler LEDs.

The above discussion now leads to the concept of vectored thermal flow and thermal impedance/conductance matching. Vectoring of the heat flow is used to distribute the heat flux, as needed to effectively move the heat away from the operating device, while simultaneously delivering it to the areas that can sink the heat away.

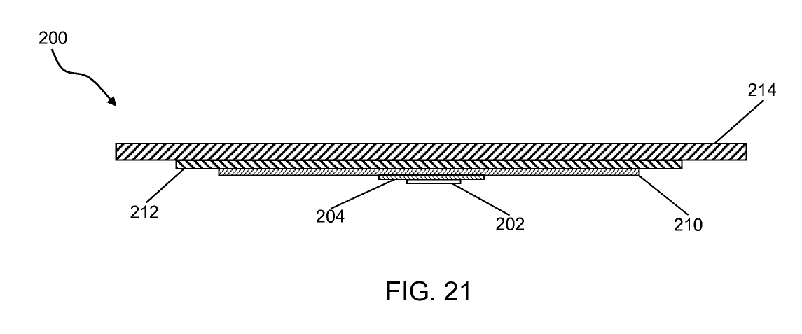

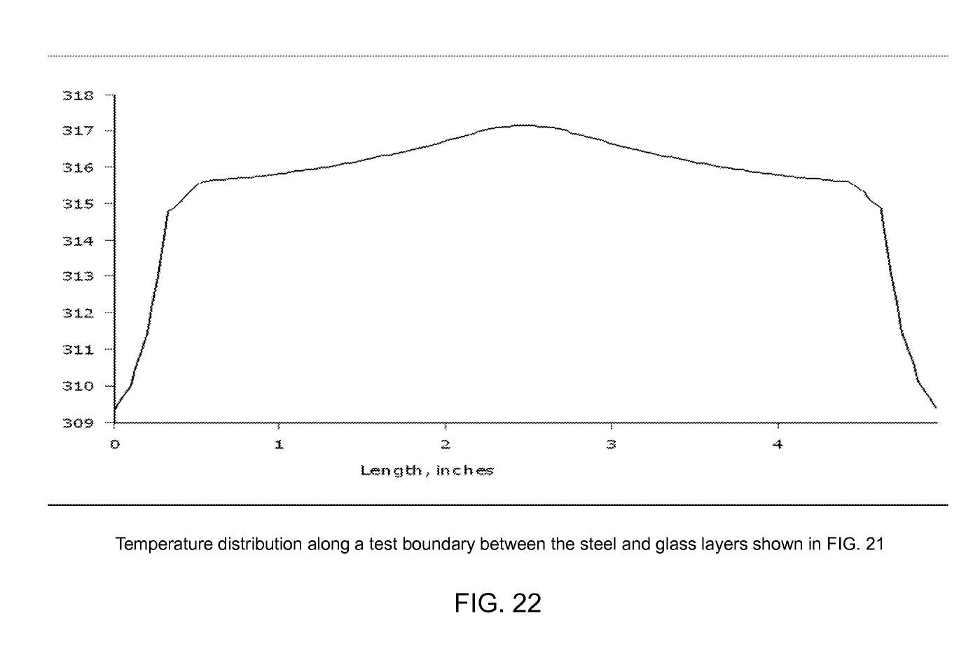

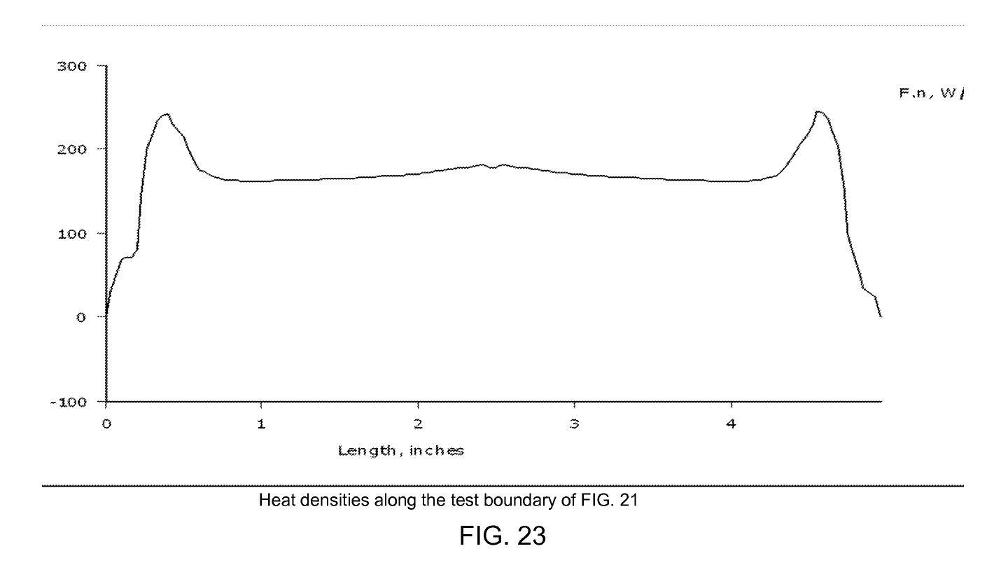

FIG. 21 shows the physical structure of a network 200 designed according to the principles of the present invention. The network 200 is composed of a plurality of layers of materials of descending thermal conductance. The LED bar is the same as described earlier with a string of LEDs 202 on a layer of copper 204 and has the same thermal loading of about 12 Watts for a thermal density of 2200 W/m². The dimensions were 5 ins×5.15 ins×0.170 ins for a volume of 4.4 in³ and a weight of 200 grams.

The layers in this example were layer one 204 of copper 0.02 ins, layer two 210 of aluminum at 0.03 ins, layer three 212 of 347 Stainless steel at 0.04 ins, and layer four 214 of glass at 0.08 ins as the final stage material. The performance of this network can be seen in FIGS. 22 and 23. The thermal distribution over the structure 200 had a thermal rise above ambient of 16° K for a temperature of 316° K. As compared to the typical finned heat sink arrangement, the system 200 is as effective at ⅙ the volume.

A closer look at the simulation output of the heat densities revealed a strong vectoring of the heat flow orthogonal to the LED bar normal vector. The densities were lower in the second layer 210 with much less variation—more uniform distribution—of heat flux density. By the third layer 212, the densities were nearly uniform.

FIG. 22 shows the temperature distribution of the network 200 as well as a test boundary between layer three 212 and layer four 214. As compared with the finned heat sink example, the distribution shows a higher thermal potential over very broad region of the network body. This is a requirement for optimal thermal flow. The nearly uniform heat flux can be seen in FIG. 23.

The effect can be explained by thermal potential equalization that takes place by the progression of thermal conductance from the highest, at the source, through intermediate layers, to a final layer that is far less dissimilar to the final transport media thermal conductance. At each layer, the thermal potential drop is equalized orthogonally to the normal heat flow vector. With the right combination of layers materials and layer thicknesses networks can be designed to use ordinary structures, e.g. walls, floors, ceiling, and tiles, for very potent heat sinks.

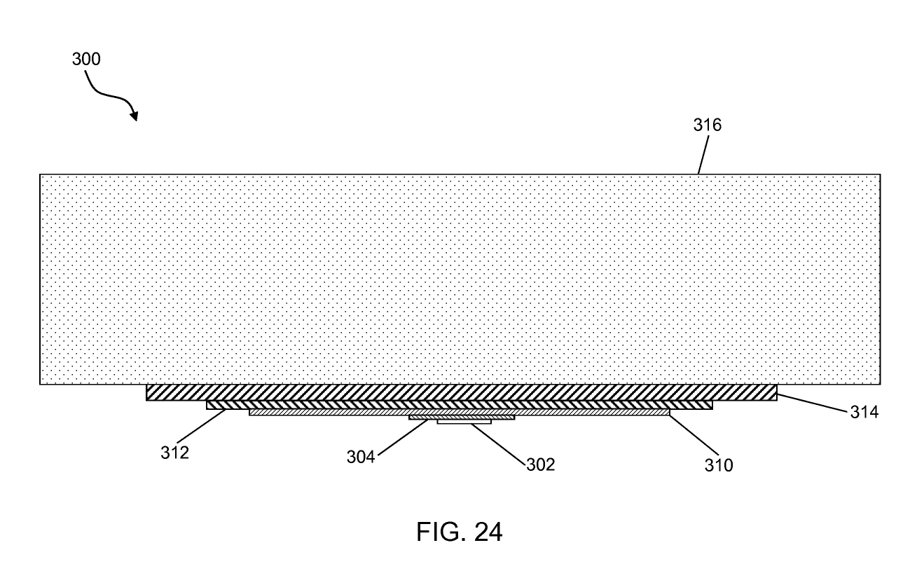

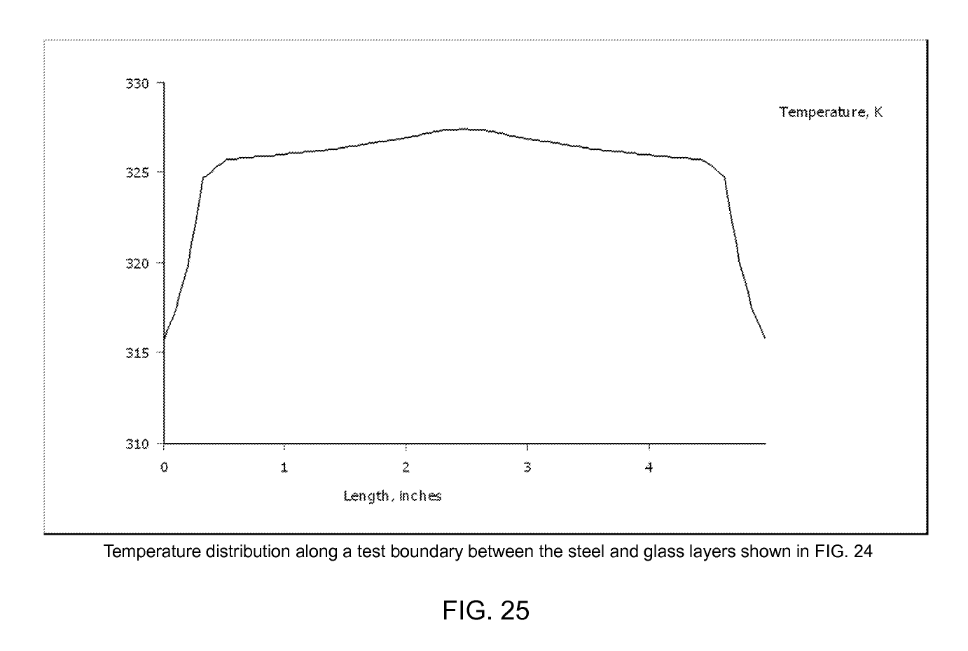

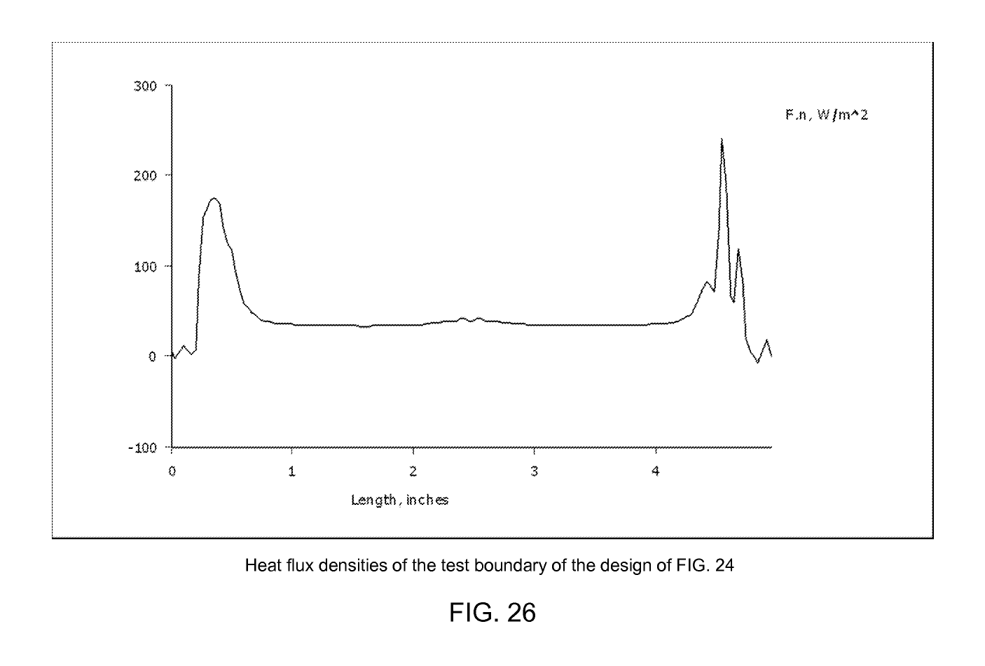

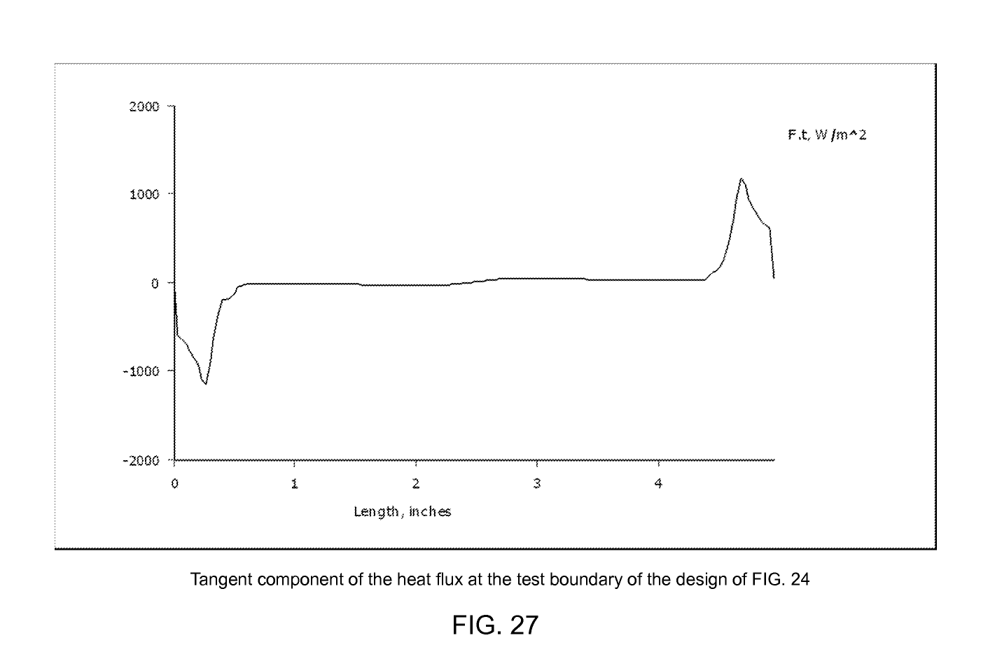

There seemed to be an under deployment for the first copper layer 204, transitioning from ˜23,000 W/m² to ˜13,000 W/m². This was by design to provide for an inherent self-adjusting property. To demonstrate, a second design 300 of the matching network. The only difference was a fifth layer 316 of a 1.0 ins layer of fiberglass insulation as illustrated in FIG. 24. Intuition would lead to the conclusion that the heat would be trapped by the insulation layer 316. In reality, as seen in Table 1, fiberglass insulation is a better conductor of heat than air by a factor of three. The effect of the insulation did not radically change the overall performance of the network 300. In this example, there was an additional 8° K rise over the previous un-insulated example (compare FIG. 25 with FIG. 22). Also, the normal heat flux vector, FIG. 26, shows a seeming reduction; however, the tangential component, FIG. 27, now comes into play. The effect of the insulation causes the network to redirect heat potentials to maximize flow.

Other designs have been tested that can properly heat sink 60 Watts on 0.2 in thick networks attached directly to cellulose ceiling tiles. Concrete, woods, plastic and many other materials classically considered thermal impediments now can be configured into effective heat removal entities thus reducing the need for metals in heat sinking applications by 80% or more.

### Example

Three devices were produced for comparison purposes. Two devices were produced according to conventional commercially available thermal dissipation methods, and one device was built according to the thermal impedance matching network of the present invention. All three devices had equivalent thermal performance. One of the conventional devices was a finned aluminum dissipation device. It weighed 497 Grams and was 5 ins×5 ins×1.2 ins. For proper free air operation the fins needed to be positioned vertically and clearance had to be at least 1.2 ins around the back side. This made the use of this very difficult with many fixture designs.

A far more complex compound device with a copper thermal spreader to embedded heat pipes distributing the heat was also built. It weighed 461 grams and was 3.4 ins×2.7 ins×2.5 ins. This device also needed proper clearances to allow for proper thermal dissipation, thus suffering the same drawbacks as the simple finned device.

The third device was an equivalent thermal impedance matching network of the present invention. It weighed 261 grams and was 4 ins×7 ins by 0.2 ins. There were no limits on front side clearance; however it needed to be in contact with wallboard or table top.

A test was carried out to measure the operation of each unit. The test allowed for free air convection with two 13 watt LEDs operating at rated power until thermal equilibration. This device has multiple orientations of which only one will give design performance. Two common orientations were applied in this test, fins vertical and then horizontal. The proper placement is fin vertical to allow convective air currents to pass through the fins and remove heat. The fins horizontal mode destroys effective air convection through the fins and is less effective.

The configuration of the first prior art unit was with fins vertical and one LED above the other thus creating a different temperature in the two LEDs. At 25° C. ambient and 26 watts power the fins vertical configuration, the lower LED achieved 71° C. and the upper LED achieved 74° C. Tests with fins horizontal, which is technically a wrong configuration, negated the differential temperature, and the LEDs reached equilibrium at 77° C.

It should be noted that the above test allowed clearances around the heat sink that would not be allowed in real world application. The sheer volume of the heat sink is 30 in³. To provide for proper free air convective current a 50% to 100% additional volume is needed to properly utilize this device.

The horizontal orientation had the same limitations; however, the convective efficiency was reduced making it not much better than a flat aluminum plate.

If this type of thermal management is utilized fixture flexibility is comprised as to its orientation, and the required clearances will limit its aesthetic appeal.

Similar testing was carried out on the second prior art unit, which is a compound heat sink. This is because of the use of multiple materials such as: a copper header, an aluminum base, heat pipes, and fabricated fins. At 26 Watts and 25° C. ambient the equilibrated temperature was 79.3° C. The unit weighed 461 grams with a volume of 23 in³. While there were small savings in volume and weight, they were vastly offset by the cost of such a device.

The thermal impedance matching device of the present invention was tested in normal horizontal position. In this position, the heat flow is nearly all conductive sinking to support surface on which it rests, in this case a table top. Convection is a very small part of the heat flow and thus could be completely enclosed without affecting the equilibrated temperature. At 26 Watts 25° C. ambient, the final temperature was 79° C. The unit weighed 261 grams 130 grams of which was window glass, 31 grams were copper, 60 grams were steel and 40 grams were aluminum. The volume was 5.6 in³, and the device did not require additional space for proper operation.

Compared to the simple finned aluminum device there was a 47% reduction in weight and an 82% reduction in volume. Compared to the compound device there was a 44% weight improvement and 76% reduction in volume.

The only limitation in applying the thermal impedance device was that it needed to be in contact with wallboard, wood thick paper or concrete.

### Example

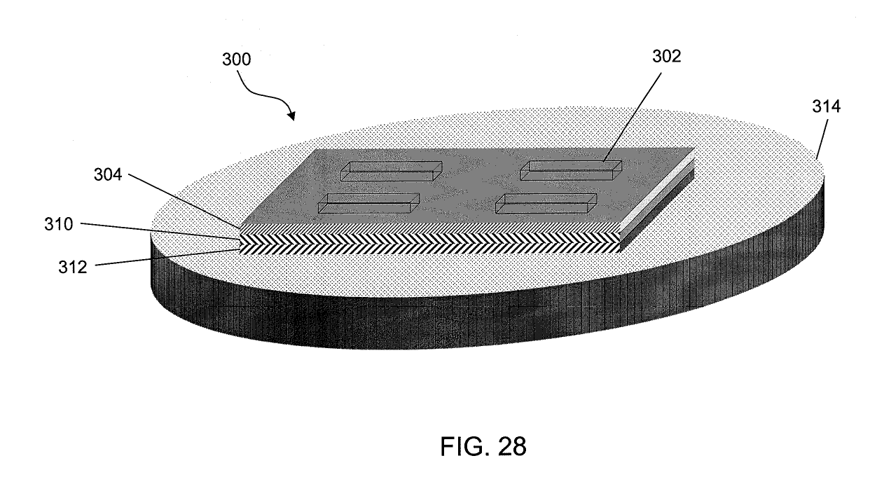

Another example of an application of the present invention is illustrated in FIG. 28. A network 400 includes a 24 Watt LED array 402, with a first layer of copper 404, a second layer of aluminum 410, a third layer of glass 412, and a fourth layer of a compressed cellulose fiber board 414.

### Example

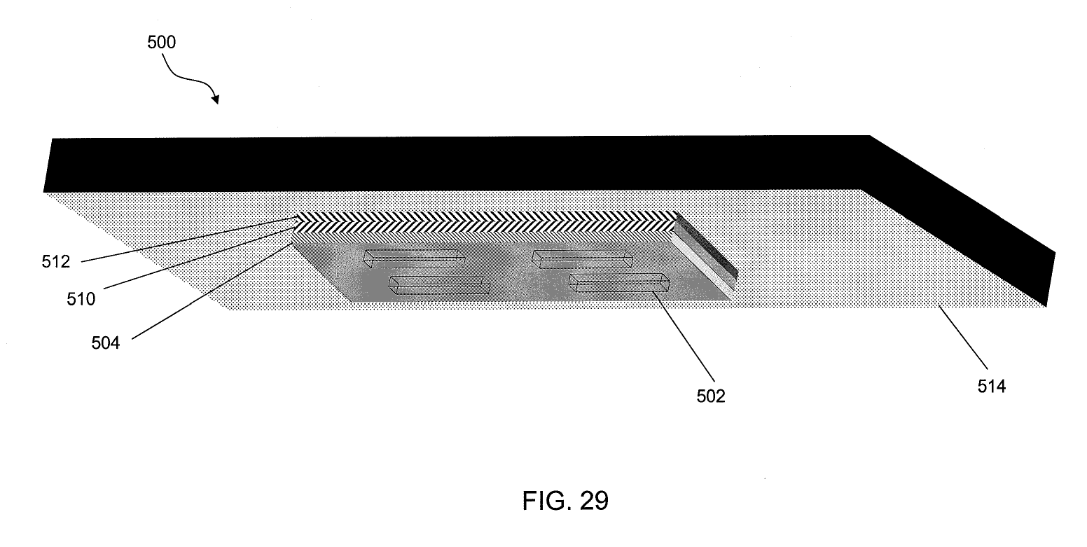

Another example of an application of the present invention is illustrated in FIG. 29. A network 500 includes a 60 Watt LED array 502, with a first layer of copper 504, a second layer of aluminum 510, a third layer of glass 512, and a fourth layer of a cellulose paper ceiling tile 514.

### Example

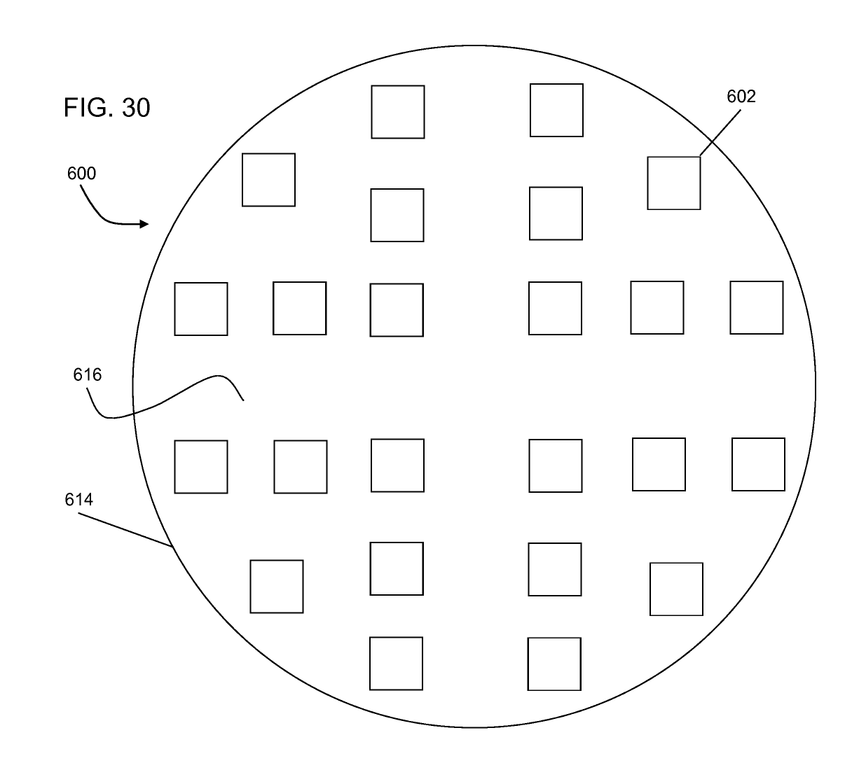

FIG. 30 is a system 600 having a 350 Watt LED array 602 where the final layer 614 is a concrete backing board. The concrete has an aluminum foil 616 to hide the concrete layer 614. Each LED is backed by first, second, and third layers of copper, aluminum, and stainless steel.

The devices described in the examples generally use a technique of stacking or layering wherein a surface of each subsequent layer is in thermal communication, preferably engaging, a surface of the preceding layer as shown consistently throughout the figures.

The terms “first,” “second,” “upper,” “lower,” “top,” “bottom,” etc. are used for illustrative purposes relative to other elements only and are not intended to limit the embodiments in any way. The term “plurality” as used herein is intended to indicate any number greater than one, either disjunctively or conjunctively as necessary, up to an infinite number. The phrase “stacked relationship” is generally intended to indicate successive layers of material having thermal impedances. Layers in “stacked relationship” tend to engage successive layers in the stack. “Stacked relationship” includes successive annular layers as well as generally planar members and combinations of the same as described and shown in the drawings.

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

While the specific embodiments have been illustrated and described, numerous modifications come to mind without significantly departing from the spirit of the invention, and the scope of protection is only limited by the scope of the accompanying Claims.

1.-28. (canceled)

29. A method of dissipating heat from a source of heat comprising:
providing a source of heat;
providing a first layer of a first material having a first thermal conductivity adjacent the source of heat;
providing a second layer of a second material having a second thermal conductivity adjacent the first layer; and
selecting volumetric dimensions of the first and second layers to match a thermal impedance of the first layer to a thermal impedance of the second layer and to minimize a change in temperature from the first layer to the second layer.

30. The method of claim 29 wherein a desired temperature change from the first layer to the second layer zero degrees.

31. The method of claim 29 further comprising the step of:
establishing an average temperature of the first and second layers wherein the average temperature of the first and second layers is nearly uniform over the volume of the first and second layers.

32. The method of claim 29 further comprising the step of:
selecting volumetric dimensions of the first and second layers to match a thermal impedance of the first layer to a thermal impedance of the second layer to control a desired change in temperature from the first layer to the second layer according to the equation:
$$\frac{{W}_{1} * {L}_{1}}{{A}_{1} K {°}_{1}} = \frac{{W}_{2} * {L}_{2}}{{A}_{2} K {°}_{2}}$$
wherein W₁ is a load on the first layer expressed in watts, W₂ is a load on the second layer expressed in watts, L₁ is a thickness of the first layer expressed in meters, L₂ is a thickness of the second layer expressed in meters, A₁ is a surface area of the first layer expressed in square meters, K°₁ is a desired temperature of the first layer expressed in degrees Kelvin, K°₂ is a desired temperature of the second layer expressed in degrees Kelvin, and A₂ is a surface area of the second layer expressed in square meters.

33. The method of claim 29 wherein a desired temperature of a first layer in the plurality of layers is about equal to a desired temperature of a second layer in the plurality of layers, a load on the first layer is equal to a load on the second layer, wherein the volumetric dimensions of the first layer and the second layer are selected according to the equation:
$$\frac{{T}_{C 1}}{{T}_{C 2}} = \frac{\frac{{L}_{2}}{{A}_{2}}}{\frac{{L}_{1}}{{A}_{1}}}$$
wherein T_{C1} is the thermal conductivity of the first layer, T_{C2} is the thermal conductivity of the second layer, L₁ is a thickness of the first layer, L₂ is a thickness of the second layer, A₁ is a surface area of the first layer, and A₂ is a surface area of the second layer.

34. The method of claim 29 further comprising the step of:
equalizing a thermal potential drop at the first and second layers orthogonally to a normal heat flow vector.

35. The method of claim 29 further comprising the step of:
creating a nearly uniform heat flux density in the first and second layers.

36. A method of passively dissipating heat from a source of heat comprising the steps of:
forming a plurality of successive layers of thermally conductive materials each having a thermal conductivity less than a thermal conductivity of a preceding layer wherein the plurality of successive layers comprises at least a first layer, a second layer, and a third layer in stacked relationship; and
matching thermal impedances of the plurality of successive layers to achieve a desired temperature change from one layer to an adjacent layer in the plurality of successive layers by controlling a volume of one layer relative to an adjacent layer in the plurality of successive layers.

37. The method of claim 36 wherein the desired temperature change from one layer to an adjacent layer in the plurality of successive layers is zero.

38. The method of claim 36 further comprising the step of:
establishing an average temperature of each layer in stacked relationship wherein the average temperature of each layer is nearly uniform over the volume of each layer.

39. The method of claim 36 further comprising the step of:
selecting volumetric dimensions of the first and second layers to match a thermal impedance of the first layer to a thermal impedance of the second layer to control a desired change in temperature from the first layer to the second layer according to the equation:
$$\frac{{W}_{1} * {L}_{1}}{{A}_{1} K {°}_{1}} = \frac{{W}_{2} * {L}_{2}}{{A}_{2} K {°}_{2}}$$
wherein W₁ is a load on the first layer expressed in watts, W₂ is a load on the second layer expressed in watts, L₁ is a thickness of the first layer expressed in meters, L₂ is a thickness of the second layer expressed in meters, A₁ is a surface area of the first layer expressed in square meters, K°₁ is a desired temperature of the first layer expressed in degrees Kelvin, K°₂ is a desired temperature of the second layer expressed in degrees Kelvin, and A₂ is a surface area of the second layer expressed in square meters.

40. The method of claim 36 wherein a desired temperature of a first layer in the plurality of layers is about equal to a desired temperature of a second layer in the plurality of layers, a load on the first layer is equal to a load on the second layer, wherein the volumetric dimensions of the first layer and the second layer are selected according to the equation:
$$\frac{{T}_{C 1}}{{T}_{C 2}} = \frac{\frac{{L}_{2}}{{A}_{2}}}{\frac{{L}_{1}}{{A}_{1}}}$$
wherein T_{C1} is the thermal conductivity of the first layer, T_{C2} is the thermal conductivity of the second layer, L₁ is a thickness of the first layer, L₂ is a thickness of the second layer, A₁ is a surface area of the first layer, and A₂ is a surface area of the second layer.

41. The method of claim 36 further comprising the step of:
equalizing a thermal potential drop at each layer orthogonally to a normal heat flow vector.

42. The method of claim 36 further comprising the step of:
creating a nearly uniform heat flux density in each layer in stacked relationship.

43. The method of claim 36 wherein at least the first layer and the second layer have a lower surface in an engagement with an upper surface of an adjacent successive layer and wherein each layer having the lower surface in engagement with the upper surface of the adjacent successive layer has a surface area less than a surface area of the upper surface of the adjacent successive layer.

44. A device for dissipating heat from a source of heat comprising:
a source of heat; and
a plurality of successive layers of thermally conductive materials comprising:
a first layer of the plurality of layers in engagement with the source of heat and having a first thermal conductivity and first thermal impedance; and
a second layer of the plurality of layers in engagement with the first layer and having a second thermal conductivity not equal to the first thermal conductivity, the second layer having a volume relative to a volume of the first layer wherein a second thermal impedance of the second layer relative to the first thermal impedance of the first layer is matched to produce a desired temperature change from the first layer to the second layer.

45. The device of claim 44 wherein the plurality of successive layers of thermally conductive materials further comprises:
a third layer in engagement with the second layer and having a third thermal conductivity not equal to the first thermal conductivity and the second thermal conductivity, the third layer having a volume relative to a volume of the second layer wherein a third thermal impedance of the third layer relative to the first thermal impedance of the first layer and the second thermal impedance of the second layer is matched to produce a desired temperature change from the second layer to the third layer.

46. The device of claim 45 wherein magnitudes of the first, second, and third thermal conductivities of the first, second, and third layers, respectively, descend in value from the first layer to the third layer.

47. The device of claim 46 wherein a first surface area of the first layer is in engagement with a portion of the second layer having a greater surface area than the first surface area of the first layer.

48. The device of claim 47 wherein a second surface area of the second layer is in engagement with a portion of the third layer having a greater surface area than the second surface of the second layer.
